(19) United States
(12) Patent Application Publication
(10) Pub. No.: US 2016/0103708 A1
(43) Pub. Date: Apr. 14, 2016

(54) SYSTEM AND METHOD FOR TASK EXECUTION IN DATA PROCESSING

(71) Applicant: PROFOUNDIS LABS PVT LTD, KERALA (IN)

(72) Inventor: ANOOP THOMAS MATHEW, KERALA (IN)

(21) Appl. No.: 14/879,392

(22) Filed: Oct. 9, 2015

(30) Foreign Application Priority Data
Oct. 9, 2014 (IN) 5072/CHE/2014

(51) Int. Cl. G06F 9/48

(52) U.S. Cl. CPC G06F 9/4881

(57) ABSTRACT

System and method for executing one or more tasks in data processing is disclosed. Data is received from at least one channel from multiple channels. The data is received in order to generate a corresponding result. A set of tasks is generated. The set of tasks is generated to process the data so received. The tasks receive the data as an input argument for generating the corresponding result. A worker node from a plurality of worker node is selected for executing the set of task in a pipeline. An idle worker node from the plurality of worker node is selected for executing the set of tasks. The set of task is executed by the selected worker nodes in order to generate the corresponding result. The results are stored for a predefined time in the system.

### CROSS-REFERENCE TO RELATED APPLICATIONS AND PRIORITY

The present application claims priority from Indian Patent Application No. 5072/CHE/2014 filed on Oct. 9, 2014, which is incorporated herein by reference.

### TECHNICAL FIELD

The present disclosure in general relates to data processing. More particularly, the present disclosure relates to system and method for task execution in data processing.

### BACKGROUND

Large-scale data processing involves extracting data of interest from raw data in one or more datasets and processing the data into a useful data product. The implementation of large-scale data processing in a parallel and distributed processing environment typically includes the distribution of data and computations among multiple disks and processors to make efficient use of aggregate storage space and computing power.

Various functional languages and systems provide application programmers with tools for querying and manipulating large datasets. Conventional functional languages and systems, however, fail to provide support for automatically parallelizing the data processing operations across multiple processors in a distributed and parallel processing environment. Nor do the conventional functional languages and systems automatically handle system faults and I/O scheduling.

Functional language and systems, e.g., Erland, SCALA, confer greatest ease in moulding machine action to human purpose. However, use of languages involve complexity and require highly technically-skilled programmers. Furthermore, for a normal language user (such as python user) learning functional programming methodologies based and using, map reduce paradigm might involve complexity.

Another example of popular data processing tools is scripting systems. A scripting system is a functional language system which has been modified and designed for greater accessibility to a non-skilled or less skilled programmers. The scripting systems do not contain all the features of data abstraction found in functional language system, but provide run-time variables and basic flow-of-control mechanisms for sequencing, iteration, and conditional branching and, the naming of routines one wishes to reuse. However, these scripting systems are less flexible than formal programming systems and, thus, less extensible. Further, while the scripting systems are simpler than functional language system, in most scripting systems, one can write a script that does not compile or run correctly.

### SUMMARY OF THE INVENTION

This summary is provided to introduce aspects related to system(s) and method(s) for executing one or more tasks in data processing and the aspects are further described below in the detailed description. This summary is not intended to identify essential features of the claimed subject matter nor is it intended for use in determining or limiting the scope of the claimed subject matter.

The present disclosure relates to a method for executing one or more tasks in data processing. The method being performed by one or more processors. The method comprises receiving data from at least one channel from multiple channels and generating the one or more tasks based on the data. The data provides an input argument to the one or more tasks for generating a result. The method further comprises selecting a worker node from one or more worker nodes and executing the one or more tasks in a pipeline by the work node for generating a result.

The present disclosure also relates to a system for executing one or more tasks in data processing. The system comprises a processor and a memory coupled to the processor. The memory stores a plurality of modules to be executed by the processor and the plurality of modules are configured to receive data from at least one channel from multiple channels and generate the one or more tasks based on the data. The data provides an input argument to the one or more tasks for generating a result. The plurality of modules are further configured to select a worker node from one or more worker nodes and execute the one or more tasks in a pipeline by the work node for generating a result.

### BRIEF DESCRIPTION OF DRAWINGS

The detailed description is described, with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for executing one or more tasks in data processing, in accordance with an embodiment of the present subject matter;

FIG. 2 illustrates modules of a system for executing one or more tasks in data processing, in accordance with an embodiment of the present subject matter;

FIG. 3 shows a flow chart of method for executing tasks in data processing, in accordance with an embodiment of the present subject matter; and

FIG. 4 shows an example of task generation and execution, in accordance with an embodiment of the present subject matter.

### DETAILED DESCRIPTION

While aspects of described system and method for executing one or more tasks in data processing may be implemented in any number of different computing systems, environments, and/or configurations, the embodiments are described in the context of the following exemplary system.

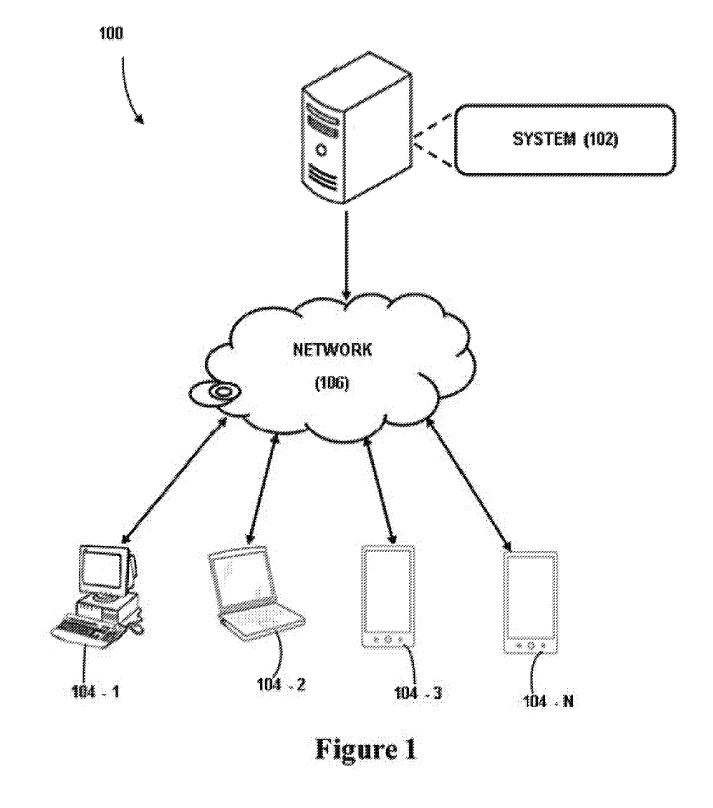

Referring now to FIG. 1, a network implementation 100 of system 102 for executing one or more tasks in data processing is disclosed. Data is received from at least one channel, from multiple channels. The data is received in order to generate a corresponding result. A set of tasks is generated. The set of tasks is generated to process the data so received. The tasks receive the data as an input argument for generating the corresponding result. A worker node from a plurality of worker node is selected for executing the set of task in a pipeline. An idle worker node from the plurality of worker node is selected for executing the set of tasks. The set of task is executed by the selected worker nodes in order to generate the corresponding result (result). The results are stored for a predefined time in the system.

Still referring to FIG. 1 although the present subject matter is explained considering that the system 102 is implemented as an application on a server. The system may also include one or more servers for implementing the application. The server comprises an advertisement server, an identification server, a work server and an identity management server.

It may be understood that the system 102 may also be implemented in a variety of computing systems, such as a laptop computer, a desktop computer, a notebook, a workstation, a server, a network server, and the like. In one implementation, the system 102 may be implemented in a cloud-based environment. The system may comprise one or more servers. The server may comprise a mobile vehicle station server, and a location server. The components and modules of the server are implemented as software and/or hardware components, such as a field programmable gate array (FPGA), an application specific integrated circuit (ASIC), and the like which performs certain tasks.

It will be understood that the system 102 may be accessed by multiple users through one or more user devices 104-1, 104-2 . . . 104-N, the user devices 104 collectively referred to as user device 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the interact, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

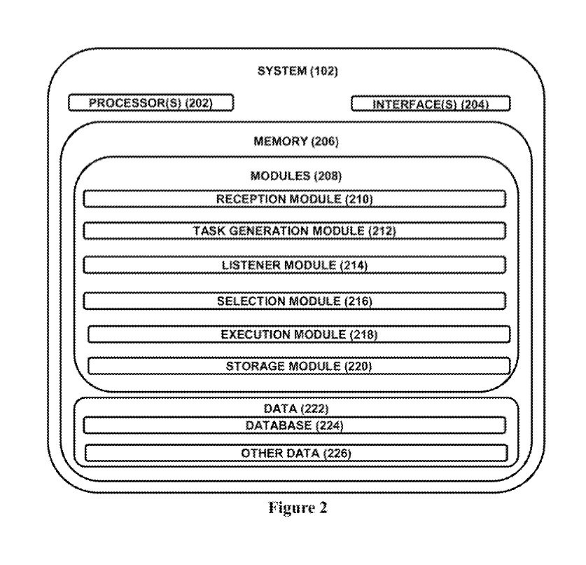

Referring now to FIG. 2, the system 102 is illustrated in accordance with an embodiment of the present subject matter. In one embodiment, the system 102 may include at least one processor 202, an input/output (I/O) interface 204 (herein a configurable user interface), a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 222.

The modules 208 include routines, programs, objects, components, data structures, etc., which perform particular tasks, functions or implement particular abstract data types. In one implementation, the modules 208 may include a reception module 210, a task generation module 210, a listener module 214, a selection module 216, an execution module 218, and a storage module 220. Other modules may include programs or coded instructions that supplement applications and functions of the system 102.

The data 222, amongst other things, serves as a repository for storing data processed, received, and generated by one or more of the modules. The data 226 may also include a database 224, and other data 226. The other data 226 may include data generated as a result of the execution of one or more modules.

In an example embodiment, the system 102 includes one or more servers. The advertisement server of the one or more servers maintains a record of the click through rates of a particular advertisement served to a plurality of websites. An identification server of the one or more servers maintains a record of the data collected from a plurality of users. An identity management server of the one or more servers maintains a record of various identifiers related to a plurality of mobile devices.

The reception module 210 receives a request for creating a pipeline of tasks to be executed. Each task request contains a function to be executed, data and unique id. The reception module 210 receives data from at least one channel from multiple channels. Before the data is received, the data is collected by the one or more servers (as described above) and then is sent to the at least one channel. The data is used for generating one or more tasks (or a set of tasks) by the task generation module 212. The task generation module 212 generates a pipeline of the one or more tasks. The pipeline is a collection of the one or more tasks where each task from the one or more tasks generates a different result.

The data can be communicated in three ways between the one or more tasks for generation of the one or more tasks. In first way, the data can be communicated as a part of the job description sent to the one or more worker nodes. In second way, the data can be communicated as a link to data source that will be passed around with the job description. The link may then be fetched at the time of the execution of the one or more tasks by the one or more worker nodes.

In third way, the data is passed from a first task to a last task like a global maxim name space. The global maxim name space is like a private store per pipeline instance. Under the third way, a common data required for most of the tasks from the one or more tasks in the pipeline can be passed around.

The one or more tasks so generated are of a short duration. The short duration refers to the one or more tasks with a medium size piece. The short duration tasks (or the one or more tasks with a short life span) provides a plurality of advantages. In an example, tasks like scraping are I/O heavy tasks and require time to finish. Running the scraping tasks parallel by using the system 102 may boost a throughput of the system 102.

The one or more tasks with short duration will help in easier recovery in case of a disaster. As the system 102 would require restarting of just one failed task instead of restarting the pipeline of the one or more tasks. Splitting of task in one or more tasks of short duration helps in testing debugging. The short duration of the tasks also helps in production of pipeline in a quicker time.

Each task from the one or more tasks receives a set of arguments as input in order to produce results related to the arguments. The set of arguments are provided by the data.

The system 102 further comprises the listener module 214 configured to listen to each channel from the multiple channels while receiving the data. Each task from the one or more tasks is connected to the listener module 214 in order to receive the arguments. The listener module 214 also determines an availability of data with the channel from the multiple channels. The listener module 214 may also listen to multiple channels to enable reception of the data by the reception module 210.

The selection module 216 selects a worker node from the one or more worker nodes for executing one or more tasks. The worker server manages the one or more worker nodes in a worker network. The worker network is a network of one or more computers. The one or more computers in the worker network are worker nodes for executing one or more tasks. The selection module selects an idle worker node for executing the one or more tasks.

The worker node from plurality of worker nodes selects the task from the one or more tasks to execute the one or more tasks. The channel carries results from the one or more tasks executed previously. The results from the one or more tasks executed previously serve as arguments for a subsequent tasks from the one or more tasks.

The worker node selects and executes the one or more tasks through the execution module 218. Each task of the one or more task is executed independently by the worker node. Each of the one or more tasks is executed by different worker nodes for different set of arguments. The worker server provides an easy scaling with plurality of workers listening to the channel.

The storage module 220 stores the results generated by the one or more tasks. The results generated by the one or more tasks are forwarded to the channel. In an embodiment, the storage module 220 is a time limited data depot for storing results from the one or more worker node. The storage module 220 publishes the results according to a predefined timeout. The timeout enables the system 102 to be resilient to unexpected error at the time of task execution and to work without hindering other successful processes.

In an example, the storage module 220 stores results from task execution for a pre-determined period in order to meet a deadline. In another example, the storage module 220 stores results from task execution for a predetermined period, in order to wait for results from pending task executions. The system 102 also comprises a centralized state store for keeping, a track of each and every change in an execution state by the execution module 212.

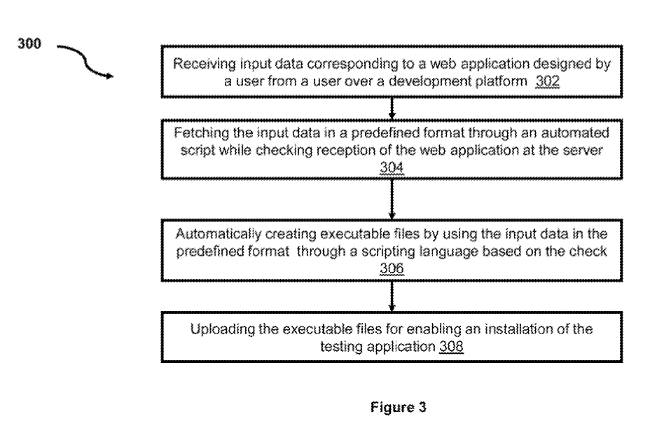

Referring now to FIG. 3, a flowchart of method 300 for executing tasks in data processing, is shown, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The method 300 initiates at step 302. At step 304, the listener module 214 listens to the channel 10$ for data. At step 306, the availability of data in the channel is determined. If data is available in the channel 108, the method 300 proceeds to step 308. If data is not available in the channel 108, the method 300 repeats step 304.

At step 308, one or more tasks are generated to be executed by worker nodes in the worker network. In an embodiment, each of the one or more tasks is of short duration. Each of the one or more tasks is independently executed by the worker nodes. In another embodiment, each of the one or more tasks receives the set of arguments as the input in order to produce results related to the arguments.

In yet another embodiment, each of the one or more tasks is executed by different worker nodes for different set of arguments. The data received from the channel is the argument for the one or more tasks, The data received from the channel is raw data to be processed. The data received from the channel is results produced by tasks generated previously.

At step 310, one or more worker nodes in the worker network 108 are selected to execute at least one of the one or more tasks generated in step 308. The idle worker from the one or more workers in the worker network is selected to execute at least one of the one or more tasks. At step 312, the one or more tasks are executed by the one or more worker nodes selected in step 310. The results from the executed tasks are stored and served as arguments to subsequent tasks. The flow chart 300 terminates at step 314.

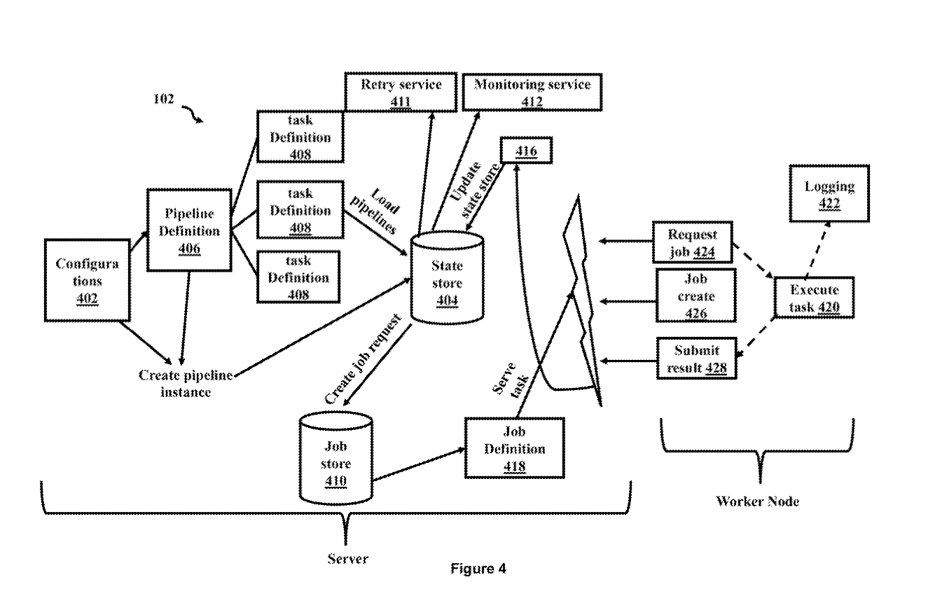

In an example embodiment, referring to FIG. 4, a task generation and execution is shown. From a configuration block 402 Settings for execution to be defined for each server and worker node, pipeline instances are created and updated with a State store in block 404, The state store is a global store where details of each pipeline instances and jobs in each pipeline will be stored. The state store will maintain the status of each jobs and completion results Pipeline definition. Block 406 provides task definition in block 408. Each problem is defined as a pipeline, composed of tasks, each transferring data in between tasks. In block 408, definition of task is to be executed in each of the worker node. The task definition loads the pipelines at the state store 404. Request for creating a pipeline of tasks (creating job request) to be executed is received by a job store block 410 from the state store 404. Block 410, Stores job instances of each of the new task created. This tracks the job description, data, retry and timeouts of all the job requests created. The state store 404 also communicate with the retry service 411 and monitoring service 412 for updating the state store 404. Block. 412 provides the error tracking and monitoring for each task for fault tolerance and reporting. The state store 404 is also updated by the block. 416 according to execution of tasks. Posted results on (428), will be updated to state store (404) in the each of pipeline instances.

The job store block 410 provides job definition in block 418 to provide server tasks to be executed by the worker node. Task instances are called jobs. Each definition will have job description with functions, data retry, timeout, and unique job id. In block 420, worker execute job in the job description over the data sent through the job description. Block 422 provides Logging of each task execution on the worker node. At the worker node, the task is executed in block 420 based on logging in block 422. The execute task in block 420 also receives request job from block 424 and a submit result from block 428. The block 424 request a new job as an instance of tasks from the pipeline definition The job create request in block 426 is also communicated to the server. Block 426 create a new job based on the job request. The block 428 provides submit result. Once the task is done, workers will send back results to the server.

System 102 starts with a first task in the pipeline and create a job description for the first task. The job description is then released into the channel. The worker node picks up the job description associated with the task and execute the task for generating a result. After the execution, of the task, the result is returned, to a result channel. The server maintains a state of the pipeline execution and update the jobs as complete.

In another example embodiment, let us consider a case of finding a Root Mean Square (RMS) value of a list of very huge numbers (list of inputs) by the system 102. The system 102 creates four functions. First function is for accepting a list of inputs, second function is for finding a square (square function) where number is data and task is to identify the execution, third function is for finding a mean of a list of huge numbers, and fourth function is fur another square root of a number.

Input for the first function is the list of very huge numbers and the output obtained is nothing. The first function will create a job request for second function for finding square each number in the list of huge numbers. For second function, a mean function will be invoked after all numbers in the huge list of numbers are squared. Mean of the list of squares is then determined in third function. The second function will return the mean and invoke the fourth function to find the square root of the mean of the list of squares. Result of the square root of the mean of the list of squares is returned to a caller of the pipeline. The result may be one of a blocking call or a non-blocking call to the pipeline. Results are published to a specified location and are accessible from the caller function.

The system 102 and method can be implemented in one or more type of data processing pipelines for executing varying tasks. The system 102 and method may be used for I/O hound, CPU bound operations and for executing tasks in multiple languages. The system and method may be used for executing tasks running in server side and client side browsers. By this, the system 102 and method provides a language agnostic feature.

The written description describes the subject matter herein to enable any person skilled in the art to make and use the embodiments of the invention. The scope of the subject matter embodiments are defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

We claim:

1. A method for executing one or more tasks in data processing, the method being performed by one or more processors, the method comprising:
receiving data from at least one channel from multiple channels;
generating the one or more tasks based on the data, wherein the data provides an input moment to the one or more tasks for generating a result;
selecting a task from the one or more tasks by a worker node from one or more worker nodes; and
executing the one or more tasks in a pipeline by the work node for generating a result.

2. The method as claimed in claim 1, wherein the selecting comprises, selecting an idle worker node from the one or more worker nodes.

3. The method as claimed in claim 1, wherein the generating comprises:
generating a pipeline of the one or more tasks to be executed by the worker node.

4. The method as claimed in claim 1, wherein the channel carries one or more control lines for selecting a worker node from the one or more worker nodes.

5. The method as claimed in claim 1, wherein the channel carries result from a previously executed task of the one or more tasks, wherein the result of the previously executed task is used as an argument for a subsequent task from the one or more tasks.

6. The method as claimed in claim 1, comprising:
listening to the multiple channel simultaneously while receiving the data;
dividing the one or more tasks between one or more worker nodes from the plurality of nodes; and
executing the one or more tasks by the one or more worker nodes.

7. The method as claimed in claim 1, wherein the one or more tasks are of a short duration.

8. The method as claimed in claim 1, comprising:
storing results of the tasks so executed; and
publishing the results according to a predefined timeout.

9. A system for executing one or more tasks in data processing, the system comprising:
a processor; and
a memory coupled to the processor, wherein the memory stores a plurality of modules to be executed by the processor, wherein the plurality of modules are configured to:
receive data from at least one channel from multiple channels;
generate the one or more tasks based on the data, wherein the data provides an input argument to the one or more tasks for generating a result;
select a task from the one or more tasks by a worker node from one or more worker nodes; and
execute the one or more tasks in a pipeline by the work node for generating a result.

10. The system as claimed in claim 9, wherein the plurality of modules are configured to select an idle worker node from the one or more worker nodes.

11. The method as claimed in claim 9, wherein the plurality of modules are configured to:
generate a pipeline of the one or more tasks to be executed by the worker node.

12. The system as claimed in claim 9, wherein the channel carries one or more control lines for selecting a worker node from the one or more worker nodes.

13. The system as claimed in claim 9, wherein the channel carries result from a previously executed task of the one or more tasks, wherein the result of the previously executed task is used as an argument for a subsequent task from the one or more tasks.

14. The system as claimed in claim 9, wherein the plurality of modules are configured to:
listen to the multiple channel simultaneously while receiving the data;
divide the one or more tasks between one or more worker nodes from the plurality of nodes; and
execute the one or more tasks by the one or more worker nodes.

15. The system as claimed in claim 9, wherein the plurality of modules are configured to:
store results of the tasks so executed; and
publish the results according to a predefined timeout.
